(19) United States
(12) Patent Application Publication
(10) Pub. No.: US 2009/0215506 A1
(43) Pub. Date: Aug. 27, 2009

(54) SLIDER MECHANISM

(75) Inventor: Mats KLEVERMAN, Helsingborg (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/036,551

(22) Filed: Feb. 25, 2008

(51) Int. Cl. H04M 1/00

(52) U.S. Cl. 455/575.4

(57) ABSTRACT

Radio communication terminal comprising a first casing, a second casing and a slider mechanism, comprising a slider and a base, the slider is mounted on either one of the first casing and the second casing and the base is mounted on the other of the first casing and the second casing, wherein the slider mechanism further comprises at least one cam, which is mounted on either one of the slider and the base, and at least one follower, which is adapted to be moved along said cam and is mounted on the other of the slider and the base, wherein the first casing and the second casing is adapted to be moved in relation to each other between at least a first and a second position by movement of the follower along the cam.

### TECHNICAL FIELD

The present invention relates to a radio communication terminal comprising a first casing, a second casing and a slider mechanism, comprising a slider and a base, the slider is mounted on either one of the first casing and the second casing and the base is mounted on the other of the first casing and the second casing.

### BACKGROUND ART

The first commercially attractive cellular telephones or terminals were introduced in the market at the end of the 1980's. Since then, a lot of effort has been made in making smaller radio communication terminals, with much help from the miniaturisation of electronic components and the development of more efficient batteries. Today, numerous manufacturers offer pocket-sized radio communication terminals with a wide variety of capabilities and services.

In order to attract customers the terminal manufacturers have therefore taken further measures to strengthen their position in the competition. Size and cost is getting more and more essential in mobile handsets design. The marked trend is that mobile handsets are getting thinner.

Another market trend is that the shell of the mobile handset is divided into an upper and lower casing. The upper casing is connected to and movable in one direction in relation to the lower casing via a slider mechanism between an open and a closed position.

A common type of slider mechanism comprises a slider that is slideable connected to a base. The slider is connected to the upper casing and the base is connected to the lower casing. A spring member is in one end connected to the slider and in the other end connected to the base. When the mobile handset is arranged in its closed position, the spring member presses the slider away from the base in the sliding direction and locks the upper casing to the lower casing. To arrange the mobile handset in its open position, the upper casing is slideable moved in relation to the lower casing. The slider is moved towards the base and the spring member is compressed and rotated around its connection to the base. As the upper casing is moved further, the first end of the spring member has been moved passed the second end of the spring member. The spring member is now able to expand and to press the slider away from the base in an opposite direction compared to the closed position. The mobile handset is now arranged in its open position.

One known problem with prior art is that the slider mechanism takes up a lot of space as it is moved between the open and closed position.

### SUMMARY OF THE INVENTION

A radio communication terminal defined in claim 1 is provided according to the present invention.

More specifically the invention relates to a radio communication terminal comprising a first casing, a second casing and a slider mechanism, comprising a slider and a base, the slider is mounted on either one of the first casing and the second casing and the base is mounted on the other of the first casing and the second casing, wherein the slider mechanism further comprises at least one cam, which is mounted on either one of the slider and the base, and at least one follower, which is adapted to be moved along said cam and is mounted on the other of the slider and the base, wherein the first casing and the second casing is adapted to be moved in relation to each other between at least a first and a second position by movement of the follower along the cam.

An advantage of such a radio communication terminal is that the dimensions of the slider mechanism could be reduced.

A further advantage is that the dimensions of the sliding mechanism in a direction perpendicular to the slideable movement could be reduced.

Another advantage is that the sliding mechanism reduces the needs for that the surfaces between the first casing and the second casing have to bee flat.

A further advantage is that the number of moving parts is reduced, which will reduce the time of mounting and the costs.

The slider mechanism can comprise two cams, which will enhance the stability in the movement of the first casing in relation to the second casing.

To even further enhance the stability, the two cams can be arranged parallel to each other.

The follower can be arranged between the cams.

The follower can comprise a resilient member, which is adapted to press the follower against the at least one cam. By doing this the advantages of that the follower will take up any slack between the cam and the follower is obtained. A further advantage is that the resilient member can reduce the need of low tolerances in the production of the parts.

To even further enhance the stability and reduce the need of low tolerances, the resilient member can be adapted to press the follower against the two cams.

To enhance the ability of the follower to follow the cam, the follower can be resilient expandable and retractable. This also increases the possibility of designing the cams in different ways.

The follower can be adapted to be expanded and retracted when it is moved along the at least one cam.

The first position can be a closed position, in which the first casing is arranged on top of the second casing, and the second position can be an open position, in which the first casing is arranged displaced in relation to the second casing. The advantage of this is for instance that a key pad on the first casing could be hidden by the second casing in the closed position and only visibly in the open position when it should be used.

The first casing and the second casing can be adapted to be moved in relation to each other between the first, the second and a third position by movement of the follower along the cam, to even further enhance the possibilities to hide and disclose different functions of the radio communication terminal. The third position could for instance be a second open position, disclosing, for instance, a camera if the first and second casings is moved in an opposite direction to when it is moved to its second position.

The follower can be adapted to move the first casing in relation to the second casing along at least a part of the distance between the first and the second position. The advantages of this is that a user of the radio communication terminal only have to move the first and second casings a part of the distance to move it from the first and the second position, thereafter the follower moves it the rest of the distance. A further advantage of this is that the risk of that the first and second casings are stuck in an unwanted position between the first and second position is reduced.

The follower can be adapted to move the first casing in relation to the second casing along at least a part of the distance between the first and third position and at least a part of the distance between the third and the second position. The advantages of this are the same as stated above.

The follower can be adapted to move the first casing in relation to the second casing by interaction between the resilient member of the follower and the cam. This is a simple and cost effective way of obtaining that the follower moves the first casing in relation to the second casing.

The cam can have a wave shape. This is simple and cost effective way of obtaining an efficient, secure and user friendly movement between the first and second casings.

A simple and effective way of obtaining that the first and second casings is stable and stays in the first and the second positions, is that the first and the second casings can be arranged in said first and second position when the follower is arranged in valleys on the wave shaped cam.

The same advantages is obtained if the first and the second casings can be arranged in said first, second and third position when the follower is arranged in valleys on the wave shaped cam.

To reduce the risk of that the first and the second casings is separated in an unwanted manner, the base can further comprise a projection and the slider can further comprise a groove, wherein said projection can be adapted to be arranged in said groove and to slide in said groove as the first casing is moved in relation to the second casing.

### BRIEF DESCRIPTION OF THE DRAWINGS

The features and advantages of the present invention will be more apparent from the following description of preferred embodiments with reference to the accompanying drawings, in which

FIG. 1 schematically illustrates a cross section of a radio communication terminal according to prior art.

FIG. 2 schematically illustrates cross section along the line A-A in FIG. 1 of a radio communication terminal according to prior art

FIG. 3 schematically illustrates a cross section of a radio communication terminal in a first position according to an embodiment of the invention.

FIG. 4 schematically illustrates a cross section of the radio communication terminal in FIG. 3 along the line B-B.

FIG. 5 schematically illustrates a cross section of a radio communication terminal in a position between the first and the second position according to an embodiment of the invention.

FIG. 6 schematically illustrates a cross section of the radio communication terminal in FIG. 5 along the line C-C.

FIG. 7 schematically illustrates a cross section of a radio communication terminal in a second position according to an embodiment of the invention.

FIG. 8 schematically illustrates a cross section of the radio communication terminal in FIG. 7 along the line D-D.

### DETAILED DESCRIPTION

The present description relates to the field of radio communication terminals. The term radio communication terminal or communication terminal includes all mobile equipment devised for radio communication with a radio station, which radio station also may be a mobile terminal or e.g. a stationary base station. Consequently, the term radio terminal includes mobile telephones, pagers, communicators, electronic organisers, smart phones, PDA:s (Personal Digital Assistants) and DECT terminals (Digital Enhanced Cordless Telephony).

Embodiments of the present invention relate, in general, to a radio communication terminal, such as a mobile phone. However, for the sake of clarity and simplicity, most embodiments outlined in this specification are related to mobile phones.

Furthermore, it should be emphasised that the term comprising or comprises, when used in this description and in the appended claims to indicate included features, elements or steps, is in no way to be interpreted as excluding the presence of other features elements or steps than those expressly stated.

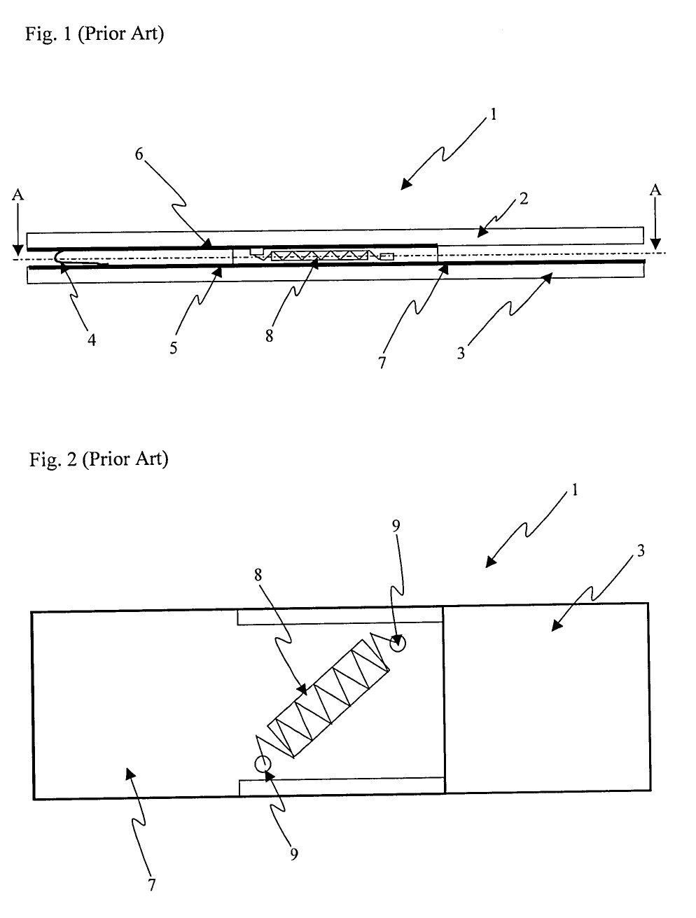

FIGS. 1 and 2 discloses a radio communication terminal 1 according to prior art and comprise a first casing 2, a second casing 3, a communication device 4 and a slider mechanism 5.

The first casing 2 and the second casing 3 could comprise a key pad, a display, a microphone, a speaker and a camera (not disclosed). These devices (and others) are known and disclosed in prior art and will thus not be described in this application. The devices in the first casing 2 could communicate with the devices in the second casing via wires in the communication device 4.

The slider mechanism 5 comprises a slider 6, a base 7 and a spring 8. The spring 8 is in one end rotatable connected to the slider 6 and in the other end rotatable connected to the base 7. The base 7 comprise a groove (not disclosed) in which the slider 6 is slideable arranged in.

The slider 6 is mounted on the first casing 2 and the base 7 is mounted on the second casing 3. The first casing 2 is slideable movable in relation to the second casing 3 between a closed position and an open position. The radio communication terminal 1 disclosed in FIG. 1 is in the closed position. To move the radio communication terminal 1 from its closed position to its opened position the first casing 2 is moved in relation to the second casing 3. As the first casing 2 is moved the slider 6 is moved together with it. The slider 6 is moved in a direction such that the ends 9, 10 of the spring 8 are moved towards each other and the spring 8 is compressed. When the slider 6 is moved further, the ends 9 of the spring 8 are moved passed each other. The spring 8 is now able to flex back and expand. As it expands it moves the first casing 2 in relation to the second casing 3 to the opened position. During this movement the slider 6 slides in the groove of the base 7.

The spring 8 is moved in a plane for a relatively long distance between the first and the second casings 2, 3. The spring 8 takes up nearly the whole width of the said casings 2, 3.

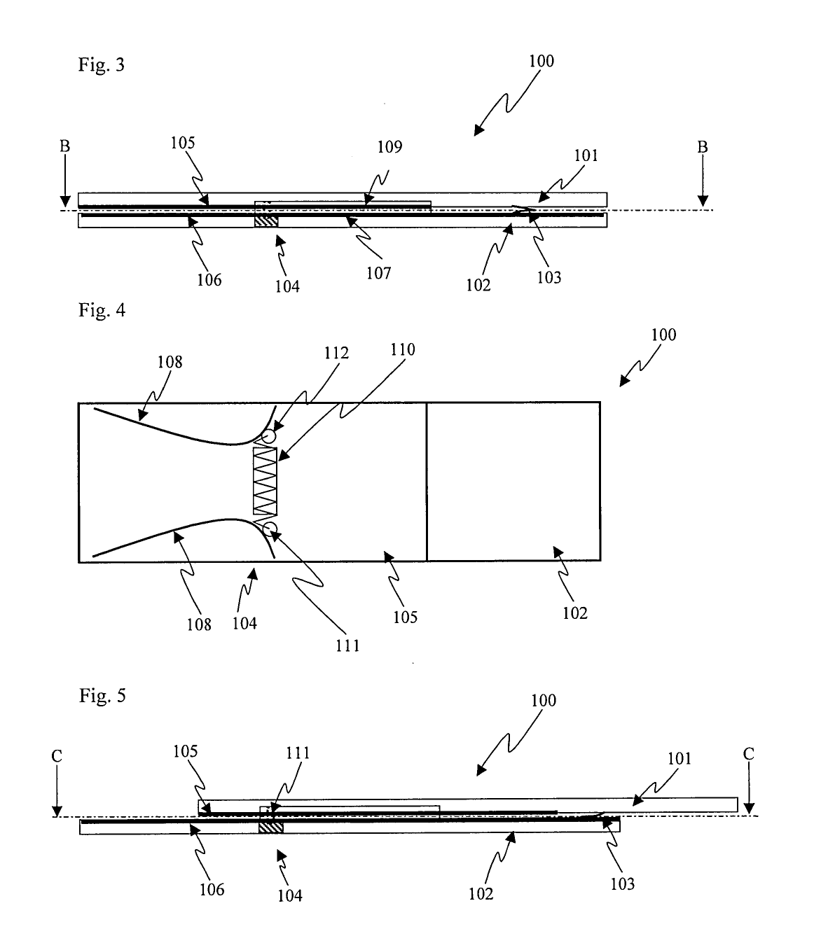

Exemplary embodiments will now be described with references made to the FIG. 3 to 8, in which an embodiment according to the invention is disclosed. FIG. 3 and 4 disclose a radio communication terminal 100 according to an embodiment of the invention in a first position. The radio communication terminal 100 comprises a first casing 102, a second casing 101, a communication device 103 and a slider mechanism 104.

The first casing 102 and the second casing 101 could comprise a key pad, a display, a microphone, a speaker and a camera (not disclosed). These devices (and others) are known and disclosed in prior art and will thus not be described further in this application. The devices in the first casing 102 could communicate with the devices in the second casing 101 via the communication device 103.

The slider mechanism 104 comprises a slider 105 and a base 106.

The slider 105 comprises a slider plate 109 and two cams 108. The slider plate 109 has a rectangular shape. The slider plate 109 comprises two projections (not disclosed) that are arranged along two opposing edges of the slider plate 109. Each cam 108 has the shape of one wave. The cams 108 are mounted on one side of the slider plate 109. The cams 108 are inverted mounted such that the wave shapes converge towards each other in the middle.

The base 106 comprises a base plate 107 and a follower 110. The base plate 107 has a rectangular shape. The base plate 107 comprises two grooves (not disclosed) that are arranged at two opposing edges of the base plate 107. The grooves have a shape that corresponds to the shape of the projections of the slider plate 109. The follower 110 has two ends 111, 112 and comprises a resilient member 113. The follower 110 is mounted on the base plate 107 such that one end 111 is directed towards one of the grooves and the other end 112 is directed towards the other groove.

To assemble the sliding mechanism 104, the projections of the slider plate 109 are arranged in the grooves of the base plate 107. The base plate 107 is slided on to the slider plate 109 such that the follower 110 is directed towards the cams 108. When the base 106 is slided on to the slider 105, one end 111 of the follower 110 makes contact with one of the cams 108 and the other end 112 of the follower 110 makes contact with the other cam 108.

The base 106 is mounted on the first casing 102 and the slider 105 is mounted on the second casing 101. The base 106 is moved when the first casing 102 is moved and the slider 105 is moved when the second casing 101 is moved.

The first casing 102 is moveable in relation to the second casing 101 between a first position, see FIG. 3 and 4, and a second position, see FIG. 7 and 8. In the first position the second casing 101 is arranged on top of the first casing 102 and the ends 111, 112 of the follower 110 are arranged at one end of the cams 108. In this position a key pad, a display or a camera on the first casing 102 could be hidden and protected by the second casing 101.

To move the first casing 102 from the first position, a user grabs the first casing 102 and moves it in relation to the second casing 101. When the first casing 102 is moved, the slider 105 is moved together with it. As the slider 106 and the cams 108 are moved, the cams 108 make contact with ends 111, 112 of the follower 110. When the base 105 is moved further towards the cams 108, the two ends 111, 112 of the follower 110 are pressed towards each other as the distance between the cams 108 is getting shorter. When the two ends 111, 112 are pressed together the dimensions of the follower 110 is getting smaller as the resilient member 113 is compressed.

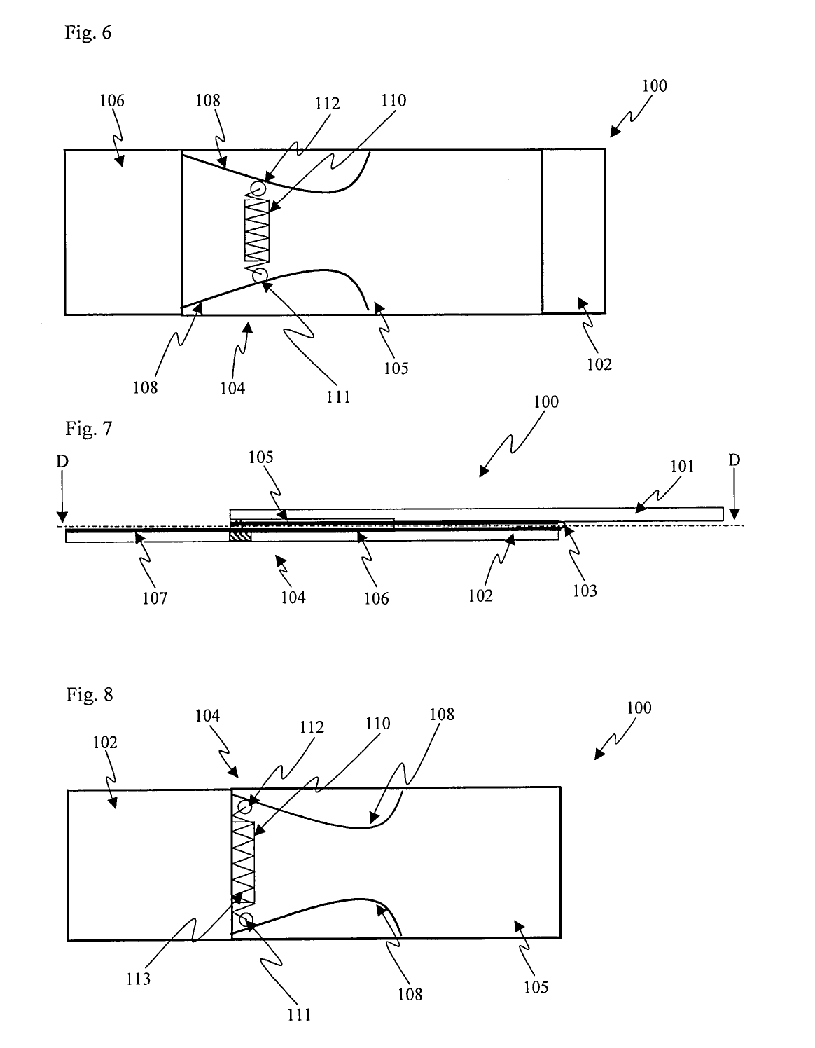

When the follower 110 has been moved passed the position in which the distance between the two cams 108 are the shortest, the resilient member 113 of the follower 110 could flex back. As the resilient member 113 flexes back the dimensions of the follower 110 is expanded and it presses the ends 111, 112 of the follower 110 against the cams 108, see FIG. 5 and 6. When the ends 111, 112 of the follower 110 is pressed against the cams 108 and the follower 110 is expanded, the slider 106, and thus also the first casing 102, is moved towards the second position. In this position the user does not have to move the first casings 102 since the follower 110 automatically moves the base 106 and the first casing 102.

When the ends 111, 112 of the follower 110 reach a second end of the cams 108, the follower 110 has been expanded to its original dimension and the movement of the first and second casings 102, 101 is stopped. The first and the second casings 102, 101 is now arranged in its second position, see FIG. 7 and 8. In the second position the first and the second casings 102, 101 have been displaced in relation to each other, this position is an open position. A key pad, a camera or a display on the first casing 102 that has been hidden by the second casing 101 could now be visible to a user.

To once again arrange the first and second casing 102, 101 in the first position the steps disclosed above is reversed.

The surfaces between the first and second casings 102, 101 and the slider mechanism 104 does not have to be flat and in a single plane. A devise, such as a camera, arranged on the second casing could project into a groove in the first casing 102, without interference from movements of the sliding mechanism 104. This makes it possible to even further reduce the size and dimensions of the radio communication terminal 101.

The surface required by the follower 110 and the cams 108 are smaller than the surface required by the sliding mechanism according to prior art.

In another embodiment the cams has the shape of two waves. This makes it possible for the first and second casings to be moved between three different positions. The third position could be an opposite position in relation to the second position, i.e. the first casing is moved in a first direction to be arranged in the second position and in a direction opposite the first direction to be arranged in the third position. As the first and second casings are arranged in the first position, a camera and a key pad could be hidden. When the first and second casing is arranged in the second position, the key pad is visible and when they are arranged in the third position the camera is visible.

It should be understood that the shape of base plate and the slider plate could be other than a rectangular shape.

The principles of the present invention have been described in the above mentioned by examples of embodiments or modes of operations. However, the invention should not be construed as being limited to the particular embodiments discussed above, which are illustrative rather than restrictive, and it should be appreciated that variations may be made in those embodiments by persons skilled in the art, without departing from the scope of the present invention as defined by the appended claims.

1. Radio communication terminal comprising a first casing, a second casing and a slider mechanism, comprising a slider and a base, the slider is mounted on either one of the first casing and the second casing and the base is mounted on the other of the first casing and the second casing,
wherein the slider mechanism further comprises at least one cam, which is mounted on either one of the slider and the base, and at least one follower, which is adapted to be moved along said cam and is mounted on the other of the slider and the base,
wherein the first casing and the second casing is adapted to be moved in relation to each other between at least a first and a second position by movement of the follower along the cam.

2. Radio communication terminal according to claim 1, wherein the slider mechanism comprises two cams.

3. Radio communication terminal according to claim 2, wherein the two cams are arranged parallel to each other.

4. Radio communication terminal according to claim 2, wherein the follower is arranged between the cams.

5. Radio communication terminal according to claim 1, wherein the follower comprise a resilient member, which is adapted to press the follower against the at least one cam.

6. Radio communication terminal according to claim 2, wherein the resilient member adapted to press the follower against the two cams.

7. Radio communication terminal according to claim 1, wherein the follower is resilient expandable and retractable.

8. Radio communication terminal according to claim 1, wherein the follower is adapted to be expanded and retracted when it is moved along the at least one cam.

9. Radio communication terminal according to claim 1, wherein the first position is a closed position, in which the first casing is arranged on top of the second casing, and the second position is an open position, in which the first casing is arranged displaced in relation to the second casing.

10. Radio communication terminal according to claim 1, wherein the first casing and the second casing is adapted to be moved in relation to each other between the first, the second and a third position by movement of the follower along the cam.

11. Radio communication terminal according to claim 1, wherein the follower is adapted to move the first casing in relation to the second casing along at least a part of the distance between the first and the second position.

12. Radio communication terminal according to claim 10, wherein the follower is adapted to move the first casing in relation to the second casing along at least a part of the distance between the first and third position and at least a part of the distance between the third and the second position.

13. Radio communication terminal according to claim 11, wherein the follower is adapted to move the first casing in relation to the second casing by interaction between the resilient member of the follower and the cam.

14. Radio communication terminal according to claim 1, wherein the cam has a wave shape.

15. Radio communication terminal according to claim 14, wherein the first and the second casings are arranged in said first and second position when the follower is arranged in valleys on the wave shaped cam.

16. Radio communication terminal according to claim 14, wherein the first and the second casings are arranged in said first, second and third position, when the follower is arranged in valleys on the wave shaped cam.

17. Radio communication terminal according to claim 1 wherein the base further comprise a projection and the slider further comprise a groove, wherein said projection is adapted to be arranged in said groove and to slide in said groove as the first casing is moved in relation to the second casing.
